(19) United States
(12) Patent Application Publication
(10) Pub. No.: US 2008/0223258 A1
(43) Pub. Date: Sep. 18, 2008

(54) Method and System for Manufacturing Lightweight, High-Strength Gypsum Products

(76) Inventors: Robert Bruce, Nanaimo (CA); Jennifer L. Worden, Nanaimo (CA)

Correspondence Address: BAKER BOTTS L.L.P., 2001 ROSS AVENUE, SUITE 600, DALLAS, TX, 75201-2980, US

(21) Appl. No.: 11/685,564

(22) Filed: Mar. 13, 2007

Related U.S. Application Data
(60) Provisional application No. 60/894,384, filed on Mar. 12, 2007.

(51) Int. Cl. C04B 16/00; B05D 3/12

(52) U.S. Cl. 106/678; 106/680; 427/355

(57) ABSTRACT

In accordance with a particular embodiment of the present invention, a method for producing a gypsum product includes providing a calcined gypsum powder. Water and an aqueous foam generated from a foaming agent comprising a first portion of sodium decyl sulfate are combined with the calcined gypsum powder to generate a foamed calcined gypsum slurry. The method may also include combining water, a foam generated from a first and second portion of the foaming agent, and the calcined gypsum powder. The second portion of the foaming agent may comprise ammonium decyl ether sulfate and ammonium octyl ether sulfate.

### RELATED APPLICATIONS

This application claims the benefit of U.S. Provisional Application Ser. No. 60/894,384, filed Mar. 12, 2007, entitled Method and System for Manufacturing Lightweight, High-Strength Gypsum Products, which is hereby incorporated by reference.

### TECHNICAL FIELD OF THE INVENTION

The present invention relates generally to gypsum product manufacturing and, more particularly, to a method and system for manufacturing lightweight, high-strength gypsum products.

### BACKGROUND OF THE INVENTION

Gypsum is used to manufacture various products such as wallboard or drywall, which is utilized in interior building construction. During the manufacture of gypsum board, such as a paper-faced gypsum wallboard or plasterboard, aqueous foam, pregenerated from a mixture of a foaming agent, air and water in a suitable continuous foam generating apparatus, is pumped to a continuous board core slurry mixer, simultaneously with the addition of a formulated calcined gypsum mixture and additional water. The benefits of entraining air bubbles into gypsum board core slurry include: (a) reduced density of the gypsum board core, resulting in a lighter weight gypsum board, and (b) a gypsum board that is less brittle during handling and attaching gypsum boards in construction applications. Lighter board allows for lower cost production and shipping and greater ease of transportation.

By way of illustration, a half inch thick gypsum board made of pure gypsum mineral would weigh about 5,900 lbs/MSF (pounds per thousand square feet). The same board made of pure gypsum, using a water/stucco weight ratio of 0.80, would weigh about 2,700 lbs/MSF (pounds per thousand square feet). By adding foam to a calcined gypsum slurry mixture during the gypsum board manufacturing process, the typical industry average board weight for a half inch thick standard gypsum board is reduced to approximately 1,625-1,650 lbs/MSF.

The continuous board core slurry mixer, commonly known as either a “pin mixer” or a “pinless mixer”, depending on its internal design elements, produces a foamed calcined gypsum slurry, which is continuously deposited upon a moving paper or other substrate supported on a long forming table, at the end of which a second substrate is applied on top of the slurry at a forming station. A liquid adhesive strip is then applied to both of the underside edges of the second substrate. Then, the edges of the first substrate are automatically folded up and turned in so that they form a bond with the adhesive strip on the underside edges of the second substrate. The result is the formation of a continuous flat ribbon sandwich of gypsum slurry between the two substrates. At this point in the process, the final width (typically four feet, or four feet six inches) and thickness (typically ¼ to 1 inch) of the gypsum board have already been determined. The resultant continuous ribbon of gypsum board next passes onto a long moving beltline, where it immediately begins to set or harden by rehydration of the calcined gypsum to gypsum. At the end of the beltline, the gypsum board is solid, and hard enough to be cut into commercially acceptable lengths (typically between eight and sixteen feet). The cut boards are then passed through a dryer to remove excess water, before being bundled into pairs for warehousing and subsequent shipment.

Depending on the specific application that a particular gypsum board will be used for, in addition to the calcined gypsum mixture, foam and water, other substances are added to the core formulation. Among such additives may be set retarders, set accelerators—such as finely ground gypsum and/or potassium sulfate, starch, water-reducing agents, moisture-resistant agents, fire-resistant agents, paper and/or chopped glass fibers, etc.

Among the effects that these additives achieve are a reduction in the amount of water required to produce a workable slurry, reduced slurry viscosity, retardation of the setting of the calcined gypsum slurry to a solid gypsum core until after the fully formulated foamed slurry has been formed into its final width, subsequent acceleration of the setting of the calcined gypsum slurry on the setting belt, increased resistance to product over-drying during manufacture, increased resistance of the final product to moisture and fire, and increased resistance to damage during shipping, handling and the installation of the manufactured gypsum board.

A concern of the gypsum board industry is how well a particular board performs under the ASTM Standard C1396/C1396M-04 Standard Specification for Gypsum Board (ASTM C1396), which defines the minimum physical properties of all gypsum board products manufactured in the U.S. All U.S. gypsum board manufacturers specify that their products will meet or exceed all requirements of ASTM C1396, when tested according to ASTM Methods C-473—Test Methods for Physical Testing of Gypsum Panel Products. Of particular concern is the Nail Pull Resistance Test (ASTM C-473, Test Method B). In order to pass the test, the gypsum board must be able to withstand a nail pull of 77 lb. force. As the weight of the board drops, the typical board loses its ability to perform satisfactorily under this Nail Pull Resistance Test.

Aqueous foam was first added to gypsum board core slurries in approximately the 1930's. Since that time, until late 1998, conventional thinking in two key areas of gypsum board strength improvement technology was:
gypsum board core voids generated by the aqueous foam (foam voids) during gypsum board slurry mixing had to be as small as possible to achieve the highest core strength.
the most critical plane of gypsum board affecting “bond strength” control was at the interface between the face papers and the gypsum board core.

However, U.S. Pat. No. 5,085,929, issued on Feb. 4, 1992 (the '929 patent), suggested that these two presumptions may not be entirely accurate. The '929 patent suggested that larger, fewer, gypsum board core voids that had thicker, stronger walls of set gypsum and reduced void-to-void interlocking produced lighter, stronger gypsum board core and gypsum board. The '929 patent also suggested that the weakest planes in the longitudinal thickness of gypsum board were not at the “paper-to-core interfaces,” but were actually within the core, in lower density planes immediately under and adjacent to the “paper-to-core interfaces” at both faces of the board.

Increasing the density of these weak planes, by causing the collapse of unstable foams in the core slurry that is deposited immediately adjacent to the face papers—due to the friction between the face papers and the foamed stream of core slurry—moved these low density “shear planes” further towards the core center—out of “harm's way.” Gypsum board may be prone to certain types of failures. One of these failures is known as a “splitter”. In a “splitter” type of failure, the paper forming the face and/or the back surface of the board is easily separated from the board core when the board is cut, normally during board installation during very humid job conditions. In a “splitter” failure, when the paper facing separates from the board it takes with it a thin-layered portion of the gypsum core. There is no paper remaining on the core surface of the board after failure, and there is an obvious thin layer of gypsum on the face of the paper that has separated from the board.

The choice of foaming agent has been known to affect the propensity of gypsum board to undergo splitter and other failures. To that end, many efforts have been made to enhance the so-called paper/gypsum “bond”. Typical of early efforts to enhance the so-called paper/gypsum “bond” are those set out in U.S. Pat. Nos. 2,940,505 and 4,327,146. More recently, “splitter” failures have been theorized to not be related to the bond between the paper and the gypsum crystals but rather the strength of the core itself in a stratum adjacent to the paper. See, for example, U.S. Pat. Nos. 5,116,671 and 5,085,929.

After the implications of the '929 patent were grasped by the gypsum board industry, several major gypsum board manufacturers around the world attempted to achieve the same results, but by other means. BPB obtained at least three patents over a three-year period, starting with a patent application in the UK on Mar. 1, 1993. These patents were based on “two-zone mixer” designs, where an unstable foam was added at the second, more gentle mixing stage of the core slurry manufacture—to avoid the premature breakdown of an unstable foam before board core formation. U.S. Pat. No. 5,643,510 to U.S. Gypsum is directed to a “dial-a-bubble” system. GEO Specialty Chemicals Inc., a gypsum board foamer manufacturer, has patented several foaming agents designed to produce large core voids in gypsum board (see e.g., U.S. Pat. No. 5,714,001).

As time was to tell, consistently achieving the results first described in U.S. Pat. No. 5,085,929 was a very tricky challenge, due to the inevitable differences in the board manufacturing processes and raw materials from plant to plant. Consequently, none of these “formula-based” developments has, so far, been consistently put into successful commercial practice on anything more than a limited scale, as standard half inch thick gypsum board weights in the marketplace remain, on average, above 1,600 lb/MSF.

The realization by the gypsum industry of the importance of eliminating the low-density layer of gypsum core adjacent to both paper-core faces of gypsum board also initiated a subsequent groundswell of activity throughout the industry to develop mechanical methods to apply “high density skins” within the board core, adjacent to both paper-core faces of the gypsum board. The technology eventually became known within the industry as “Hard Facing” or “Skim Coating”—among other descriptions. One specific method of applying high density streams of core slurry to the “bond-liner” faces of the face and back gypsum board paper is described within U.S. Pat. Nos. 5,718,797 and 5,879,486, to National Gypsum, which also illustrate the necessary additional equipment used to form these “high density skins” on the “core faces” of both papers and describes the technology.

More recently, the use of these “mechanical hard facing” methods, rather than the method of hard facing using unstable foams, as first described in the '929 Patent, has spread throughout the gypsum board industry. However, these techniques include the burdens of additional complexity, extra equipment around the mixer and the related process modifications required.

Some benefits of mechanical hard facing, versus no hard facing, are:
Elimination of separate high density slurry edges streams;
Core starch reductions of up to 70%;
Lightweight board (1,650 lb/MSF ½″ basis board weight) that meets ASTM C1396 Nail Pull Resistance Standard requirements;
Potential to further reduce board weights; and

Elimination of “splitter” complaints (failures in the lower density core planes near the paper-core interface), caused by over-drying the gypsum board.

Disadvantages of mechanical hard facing are:
An increase in process complexity;
Extra equipment around an already-congested gypsum board forming area;

The equipment requires continuous “tweaking” and cleaning to avoid problems; and
Too much high density slurry is frequently diverted to the hard facing system, thereby “robbing” slurry from the lower density core region of the board, necessitating additional additives or increased board weights to ensure the core's integrity.

As gypsum board core densities are reduced, in an effort to manufacture lighter weight gypsum board, the physical performance of the board must continue to conform to ASTM Standard C-1396- Specification for Gypsum Board, when tested according to ASTM Methods C-473—Test Methods for Physical Testing of Gypsum Panel Produces. While there is no performance requirement in ASTM Standard C-1396 regarding “splitter” types of failures, there is a specific performance requirement for “nail pull resistance”. For example, for ½″ thick gypsum board the minimum nail pull resistance value is 77 lb force (ASTM C-473, Method B).

A variety of foaming agents are known for use in the production of gypsum boards. These foaming agents have various end-use property limitations and/or undesirable processing limitations.

### SUMMARY OF THE INVENTION

The present invention relates generally to alkyl and alkyl ether sulfate surfactant blends and the use of such materials as foaming agents in formulated gypsum board core slurries (“calcined gypsum slurries”) and gypsum-based products (i.e., gypsum board, also known as drywall, plasterboard and gypsum wallboard), such that the weight of the gypsum board is reduced while its strength is maintained. The invention provides methods of preparing calcined gypsum slurries which incorporate surfactant blends, and methods of preparing lightweight, high strength gypsum board products.

These surfactant blends may be used to generate copious amounts of foam with good stability in aqueous calcined gypsum slurries. Such foam may be particularly suitable for the simultaneous entrainment of microscopic and macroscopic foam voids into the formulated aqueous calcined gypsum slurry, which ultimately becomes the core of gypsum board. Alkyl sulfate surfactant blends and alkyl and alkyl ether sulfate surfactant blends are excellent foaming agents in combination with formulated calcined gypsum slurries and can produce high strength gypsum board cores.

The present invention provides a method and system for the manufacture of gypsum products that may increase the strength and reduce the weight of the finished gypsum product.

In accordance with a particular embodiment of the present invention, a method for producing a gypsum product includes providing a calcined gypsum powder. Water and aqueous foam generated from a foaming agent comprising a first portion of sodium decyl sulfate are combined with the calcined gypsum powder to generate a foamed calcined gypsum slurry. The first portion may further comprise sodium dodecyl sulfate, and may still further comprise sodium octyl sulfate.

The method may also include combining water, a foam generated from a first and second portion of the foaming agent, and the calcined gypsum powder. The second portion of the foaming agent may comprise ammonium decyl ether sulfate and ammonium octyl ether sulfate. The second portion may further comprise ammonium decyl sulfate, and may still further comprise ammonium octyl sulfate.

The method may include various percentages of the first and second portions of the foaming agent. In accordance with a particular embodiment of the present invention, a first portion of the foaming agent comprising sodium decyl and dodecyl sulfate, comprises 90 weight percent of the total foaming agent, and the second portion, comprising C₈-C₁₀ ammonium alkyl ether sulfates and ammonium decyl sulfate, comprises the remaining 10 weight percent of the total foaming agent. The method may also include depositing the foamed calcined gypsum slurry on a first sheet and covering it with a second sheet. The combination next passes through a forming station, and the final board width and thickness is determined. As the combination travels down a moving beltline, the slurry is allowed to set until it is hard enough for individual boards to be cut. The individual boards pass through a dryer where excess water is removed, before being bundled for warehousing and shipment.

Technical advantages of particular embodiments of the present invention include a foamed calcined gypsum slurry that is easier to mix, pour, and form than foamed calcined gypsum slurry produced using conventional production methods.

Other technical advantages of particular embodiments of the present invention are significant gypsum board weight reduction, an increase in production line speed, and/or energy reductions. Each advantage may be achieved using existing gypsum board production equipment, while still producing gypsum boards of higher overall strength and quality. The lighter weight gypsum boards produced using the foaming agents described herein also result in additional cost savings in board shipping. The water based nature of the foaming agents in accordance with a particular embodiment of the present invention may reduce a detrimental effect on the environment and increase handling safety.

Another technical advantage of a particular embodiment of the present invention includes a method for producing foamed gypsum slurry that allows a half inch gypsum board to have a final dry weight of less than 1,500 lbs/MSF, with a concurrent increase in board core compressive strength of approximately 20% over conventional foaming agents. This lightweight gypsum board improves bond strength, exhibits less “splitter” type failures, and readily meets or surpasses the minimum nail pull resistance requirement of ASTM C-473- Test Methods for Physical Testing of Gypsum Panel Products. Accordingly, the need for hard facing and/or skim coating techniques may be eliminated.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 illustrates a gypsum board core slurry mixing system, in accordance with a particular embodiment of the present invention;

FIG. 2 is a flowchart illustrating a method for manufacturing gypsum board, in accordance with a particular embodiment of the present invention; and

FIG. 3 is a flowchart illustrating a method of forming foam to introduce into a calcined gypsum slurry, in accordance with a particular embodiment of the present invention.

### DETAILED DESCRIPTION OF THE INVENTION

The teachings of the present invention are directed to a system and method for manufacturing lightweight, high-strength gypsum products. Particular embodiments of the present invention may include a combination of foaming agents that allow the production of particularly lightweight gypsum board that still meets industry standards for strength.

The present invention provides a superior processable foaming agent that produces sufficiently stable foam, which can be readily prepared at low cost and is highly compatible with a variety of gypsum board compositions and manufacturing processes. Additionally, foam produced in accordance with particular embodiments of the present invention enables the production of a lightweight gypsum board with improved strength, particularly relating to paper/gypsum “bond” and nail pull resistance. The foaming agent is readily soluble in water, and does not require the use of an alcohol solubilizer, such as methanol, ethanol, or isopropanol, which incur special precautions in storage and use, thereby increasing costs.

Foaming agents have been used in gypsum board since at least the early 1930's. The original purpose for adding foam to the gypsum board core slurry was to replace additives such as cork, sawdust, perlite and vermiculite as the lowest cost and most effective means of:
Reducing Gypsum Board (Dry) Weight
Reducing Gypsum Board Cracking
Reducing Evaporable Water

Early foaming agents were great in number, and variable in quality, including natural foaming agents, such as licorice root, soap bark and complex proteins. Potassium-based rosin soaps were the mainstay of the gypsum board industry for many years.

In the late 1960's, foams based on anionic surfactants were introduced and used to advantage. These have the general structure of alkyl ether sulfates, such as “Millifoam,” “Cedepal,” “Alpha Foamer,” etc., or alkyl benzene sulfonates, e.g., “Ultrawet DS.”

Modern gypsum board foaming agents are multi-component blends of organic water-soluble chemicals known as surfactants, as are hair shampoos and shaving cream. The most common commercial surfactants belong to the alkyl sulfate and alkyl ether sulfate family of organic chemicals.

In the gypsum board industry, the terms “soap foamer, foaming blend” and “foaming agent” are interchangeably used to describe a water-based solution, which, when properly mixed with air and additional water in a suitable continuous foam generating apparatus, produces a shaving cream-like foam that is continuously added to the gypsum board core slurry mixer during gypsum board manufacture.

As previously stated, the primary purpose for using foaming agents in gypsum board is to reduce the dry weight of the board. However, foaming agents also endow other properties to the gypsum board. As discussed in this document, foams in gypsum board core can have a profound effect on a number of physical properties of the gypsum board—some not yet fully understood.

Foam acts synergistically with other core additives, particularly the water-reducing agents (dispersants), to reduce the viscosity of the board core slurry and improve the flexibility of the finished board product.

Many claims have been made by foaming agent manufacturers about the benefits that their own brand of foaming agents imparts—compared to their competitors' products, such as:
Improved board flexibility, with less cracking on handling
A reduction in mixer water requirements
A minimal effect on the slurry setting characteristics (less retarding)
Better gypsum board thickness control, (brought about by improved slurry fluidity)
A reduction in foam usage
An increase in foam stability
Better board handling, cutting, and fastening properties
An increase in the core compressive strength/density ratio
A reduction in starch usage
Low temperature flowability (of the soap)
More uniform board core structure
Large gypsum core foam bubbles
Improved gypsum board bond
Reduced gypsum board dryer temperatures

Any foaming agent, no matter how good it is claimed to be, will not perform to its full potential unless it is used in a plant environment that brings out its best qualities.

A gypsum board core slurry mix typically comprises calcined gypsum (stucco), aqueous foam and water as the major ingredients, by volume. Depending on the specific end-use application that a particular gypsum board will be used for, in addition to the calcined gypsum, foam and water, small amounts of other substances are added.

Among such additives may be slurry set retarders or accelerators (such as finely ground gypsum and/or potassium sulfate), starch, water-reducing agents, moisture-resistant agents, fire-retardant agents, paper fiber and/or chopped glass fibers, boric acid, etc. Among the effects that these additives are known to achieve are:
a reduction in the amount of water required to produce a workable gypsum board core slurry;
a reduced slurry viscosity;
the retardation of the onset of setting of the slurry to a solid gypsum board core until after the fully formulated foamed gypsum board core has been formed into its final width;
the acceleration of the setting of the calcined gypsum slurry on the setting belt;
an increased resistance to product over-drying during manufacture;
an increased resistance of the final product to moisture and fire; and
an increased resistance to damage during shipping, handling and the installation of the manufactured gypsum board.

Gypsum board core slurry mixers, called “pin” mixers, are most common in North America, and they are an integral part of a gypsum board forming table system, which typically consists of the following basic elements:
A single, side discharge, single “pant-leg” boot pin mixer with high density slurry extractors;
A forming table, including paper guides, plasterboard forming, table vibration, edge paste addition equipment, etc.; and
Hard facing systems for both face and back papers.

Typically, after exiting the pin mixer, the foamed calcined gypsum board core slurry is continuously deposited upon a moving paper sheet supported on a long forming table, at the end of which a second paper sheet is applied on top of the slurry at a forming station. Here, the underside edges of the two sheets are glued together with a liquid adhesive strip, resulting in the formation of a continuous flat ribbon sandwich of calcined gypsum slurry between the two paper sheets.

This invention is not limited to gypsum board having paper surfaces. The invention is also applicable to gypsum board having other fibrous surfaces and also to specialized gypsum board such as fire rated board, sheathing board, moisture resistant board, and the like.

In accordance with a particular embodiment of the present invention, hard edges of a foamed gypsum board may be formed by depositing a separate, higher density, stream (edge stream) of gypsum board core slurry contiguous to the edges of the main slurry stream.

At this point in the process, the final width (typically four feet, or four feet six inches) and thickness (typically ¼ to 1 inch) of the gypsum board have already been determined. The resultant continuous ribbon of gypsum board next passes onto a long moving beltline, where the calcined gypsum slurry sets or hardens by rehydration of the calcined gypsum core slurry to gypsum.

At the end of the beltline, the gypsum board is “set,” and hard enough to be cut into commercially acceptable lengths (typically between eight and sixteen feet). The cut boards are then passed through a dryer to remove excess water, before being bundled into pairs for warehousing and shipment.

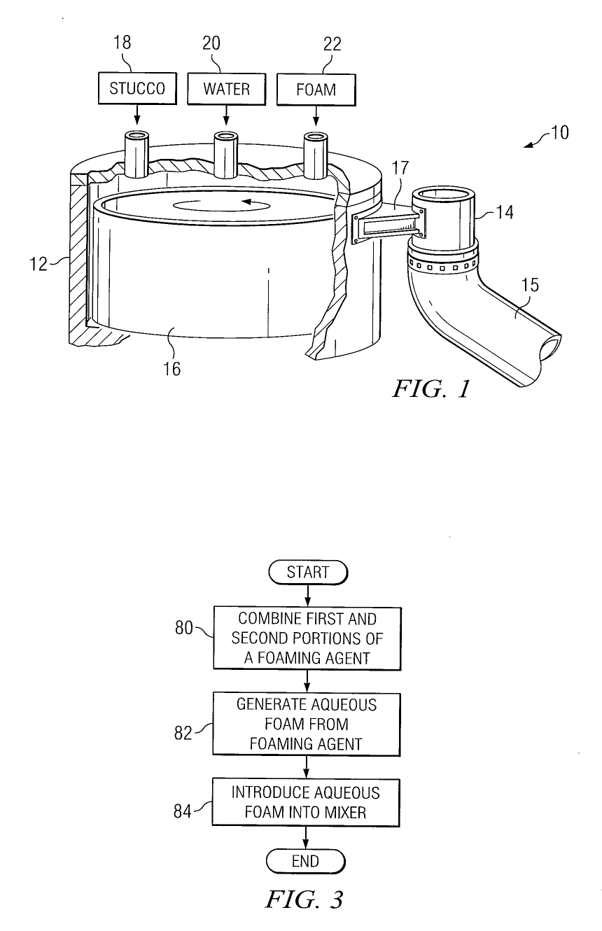

FIG. 1 illustrates a gypsum board core slurry mixing system 10, in accordance with a particular embodiment of the present invention. Gypsum board core slurry mixing system 10 includes a mixing chamber 12 and a canister 14 coupled to mixing chamber 12 by a gate 17. Mixing chamber 12 includes a lump ring 16 which helps to mix ingredients of a gypsum board core slurry within mixing chamber 12. Lump ring 16 also helps to prevent larger conglomerations of the gypsum board core slurry from exiting mixing chamber 12, only allowing a relatively evenly distributed slurry to discharge into gate 17. Calcined gypsum powder (“stucco”) 18, water 20, and foam 22 are introduced into mixing chamber 12 where they are mixed to form the calcined gypsum board core slurry that will later set and be dried to form gypsum board. Other solutions and/or ingredients may be introduced into mixing chamber 12 in the formation of the calcined gypsum board core slurry.

In operation, internal components of mixing chamber 12 rotate to mix the calcined gypsum powder 18, foam 22, and water 20 to form the calcined gypsum board core slurry. The calcined gypsum board core slurry exits mixing chamber 12, through gate 17, into canister 14 and boot 15, which completes the slurry mixing and carries it to other devices for the completion of the gypsum board manufacturing process. Mixing chambers of various sizes and configurations may be used, within the teachings of the present invention.

The introduction of foam enables the gypsum board to have a lighter weight for easier handling and transportation. Such lighter weight is a result of the significant amount of air in the foam 22 introduced into the slurry. Foam 22 may comprise a mixture of a foaming agent, water and air. Foam 22 may be introduced to gypsum board core slurry mixing system 10 using any of a variety of methods. For example, in particular embodiments, foam 22 may be introduced into the top or side of mixing chamber 12. In some embodiments, foam 22 may be introduced into a top or side of gate 17, canister 14, and/or boot 15. In yet other embodiments, foam ingredients may be introduced into the mixing chamber 12, gate 17, canister 14, and/or boot 15 and be allowed to mix therein.

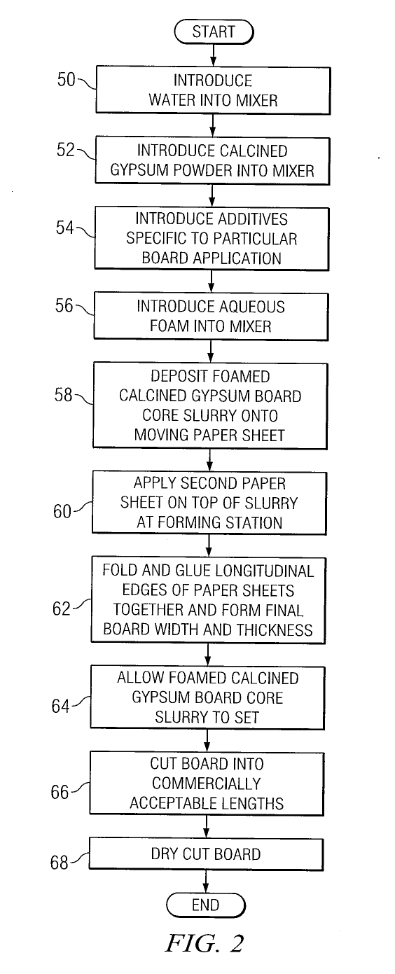

FIG. 2 is a flowchart illustrating a method for manufacturing lightweight, high-strength gypsum board in accordance with a particular embodiment of the present invention. The method begins at step 50 where water is introduced into a mixing chamber or mixer. At step 52 calcined gypsum powder (“stucco”) is introduced into the mixer to combine with the water. The combination of calcined gypsum powder and water forms a calcined gypsum slurry.

At step 54 additives specific to a particular gypsum board application may be introduced. Additives may be slurry set retarders or accelerators, starch, water reducing agents, moisture-resistant agents, fire-resistant agents, paper and/or chopped glass fibers. Additives are included in the gypsum board manufacturing process to impart specific desirable properties to the gypsum slurry and/or the final gypsum board. Additives may be added prior to or during core slurry mixing. Liquid additives may be added to the gauging water stream, the aqueous foam stream, as a separate stream, or in combination with another liquid additive or additives, separate from the main gauging water or foam streams. Dry additives may be added to the calcined stucco stream prior to being introduced into the mixer.

At step 56 an aqueous foam is introduced into the mixer. The aqueous foam may comprise one or a combination of foaming agents, water, and air. When these constituents are properly mixed in a suitable foam generating apparatus, aqueous foam may be formed. This foam may be continuously added to the calcined gypsum slurry. In another embodiment of the present invention, the foam constituents (foaming agent, water, and air) may be independently added to the calcined gypsum slurry. The aqueous foam may be similar in composition and consistency to shaving cream. The formation of aqueous foam for introduction into the gypsum slurry will be described in more detail below with reference to FIG. 3.

The foamed calcined gypsum board core slurry may be deposited on a moving paper sheet at step 58. The foamed calcined gypsum board core slurry may be continuously deposited on a moving paper sheet supported on a long forming table. Hard edges may be formed by depositing a second stream of higher density gypsum board core slurry along both longitudinal edges of the moving paper sheet. The higher density stream may form gypsum within the wrapped edges of the finished gypsum board.

At step 60, a slightly narrower second paper sheet may be applied on top of the foamed gypsum board core slurry at a forming station. Also at the forming station the two longitudinal edges of the first sheet are folded beneath the longitudinal edges of the slightly narrower upper second sheet, forming a continuous flat ribbon sandwich of foamed calcined gypsum slurry between the two paper sheets. The overlapping longitudinal edges of the two sheets may be glued together with a liquid adhesive strip, and the final board width and thickness is formed at the forming station at step 62. The result may be a continuous flat ribbon of foamed calcined gypsum board core slurry sandwiched between two paper sheets. At step 64, the board core slurry sets hard when the calcined gypsum rehydrates to gypsum, to form a wet gypsum board. This may occur as the foamed calcined gypsum board core slurry travels down a setting belt.

After the gypsum board sets, it is cut into commercially acceptable lengths (typically between eight and sixteen feet) at step 66. At step 68, the cut boards are then passed through a dryer to remove excess water before being bundled into pairs for warehousing and shipment.

Some of the steps illustrated in FIG. 2 may be combined, modified or deleted where appropriate, and additional steps may also be added to the flowchart. Additionally, steps may be performed in any suitable order without departing from the scope of the invention.

FIG. 3 is a flowchart illustrating a method for generating foam to introduce into the calcined gypsum slurry in accordance with a particular embodiment of the present invention. The method begins at step 80 where first and second portions of a foaming agent, also called soap, are combined. Most gypsum board foaming agents are multi-component blends of water soluble organic chemicals known as surfactants. A typical gypsum foaming agent has the general chemical structure of an alkyl sulfate and/or alkyl ether sulfate.

The primary purpose for using a foaming agent in gypsum board manufacturing is to reduce the dry weight of the board. However, foaming agents may also contribute to other properties of the gypsum board. Foaming agents may act with other application specific additives, particularly water reducing agents (dispersants), to reduce the viscosity of the gypsum board core slurry and the flexibility of the finished board product. Foaming agents may be selected such that the finished board product includes larger and fewer gypsum board core voids. Larger core voids may allow gypsum board to be lighter and stronger.

Different foaming agents may produce foam with bubbles that are stable or unstable. Bubbles that are unstable will coalesce to form larger bubbles more quickly than bubbles that are stable.

Foam may be created by a combination of foaming agents that produce stable bubbles and foaming agents that produce unstable bubbles. Such combinations may allow the creation of large, metastable gypsum board core voids with spherical integrity. It may also be possible to induce the controlled collapse of these same voids at or near the interface of the foamed calcined gypsum slurry and the board paper faces. This may be caused by the shearing action of the board paper faces on the foamed calcined gypsum board core slurry that takes place on the forming table. Thus, in accordance with a particular embodiment of the present invention, it may be possible to manufacture lightweight, high-strength gypsum board that includes strong core voids and high density core skins adjacent to the two paper faces. This may be accomplished without the use of mechanical hard facing equipment and technology.

The first foaming agent (or first portion of a foaming agent) may be Polystep B-25 and may be commercially available from Stepan Company. Polystep B-25 is typically used in latex manufacturing. It may be represented by the general formula I:

R_{X}(OCH₂CH₂)_{Y}OSO₃⁻M⁺ (I)

where R represents linear or branched chain hydrocarbons having an average of X carbon atoms, Y is the average number of moles of ethylene oxide per mole of R, and M⁺ is a sodium ion. Both X and Y are integers for pure compounds and non-integers (average values) for mixtures of compounds having various values of X and Y. The first foaming agent may be a blend of sodium dodecyl sulfate, where Y equals zero and X is 12, sodium decyl sulfate, where Y equals zero and X is 10 and sodium octyl sulfate, where Y equals zero and X is 8.

A second foaming agent (or second portion of a foaming agent) may be blended with the first foaming agent and introduced into the foam generator. The second foaming agent may be Cedepal FA-403 and may be commercially available from Stepan Company. Cedepal FA-403 may be water based. The second foaming agent may also be represented by general formula I. It may be described as a blend of ammonium C₈-C₁₀ alkyl ether sulfate and ammonium C₈-C₁₀ alkyl sulfate (where the average value of Y is less than 2.9 and X is equal to 8 and 10). It may be a blend of ammonium octyl ether and decyl ether sulfates and ammonium octyl and decyl sulfates, where X=8 and 10, and averages approximately 9.5, Y may be from 0-12, with an approximate value of 2.88, and M⁺ is an ammonium ion.

The chemical structure of foaming agents formed in accordance with particular embodiments of the present invention and the distribution of ethoxy fractions may be determined using high performance liquid chromatography (HPLC).

Various weight percentages of the first foaming agent and the second foaming agent may be used to form foam in accordance with a particular embodiment of the present invention. For example, in a particular embodiment of the present invention, foam may be generated by adding ninety weight percent of the first foaming agent (Polystep B-25) and ten weight percent of the second foaming agent (Cedepal FA-403). Still another embodiment may include foam that is ninety-five weight percent first foaming agent (Polystep B-25) and five weight percent second foaming agent (Cedepal FA-403).

In another embodiment of the present invention, foam may be created with eighty weight percent of the first foaming agent (Polystep B-25) and twenty weight percent of the second foaming agent (Cedepal FA-403). Still another embodiment may include foam that is seventy-five weight percent first foaming agent (Polystep B-25) and twenty-five weight percent second foaming agent (Cedepal FA-403). Foam formed in accordance with yet another embodiment of the present invention may be seventy weight percent first foaming agent (Polystep B-25) and thirty percent second foaming agent (Cedepal FA-403). Other ingredients may be added to the foam in addition to, or in lieu of Polystep B-25 and/or Cedepal FA-403.

Combinations of the first foaming agent and the second foaming agent may vary. For instance, the first foaming agent (Polystep B-25) may comprise from seventy through ninety-five weight percent of the combination and the second foaming agent (Cedepal FA-403) may comprise five through thirty weight percent of the combination. Another embodiment may include from seventy-five through ninety weight percent of the first foaming agent (Polystep B-25) and ten through twenty-five weight percent of the second foaming agent (Cedepal FA-403). Foam formed in accordance with yet another embodiment of the present invention may include from eighty through eighty-five weight percent of the first foaming agent (Polystep B-25) and from fifteen through twenty weight percent of the second foaming agent (Cedepal FA-403).

At step 82, aqueous foam is generated from the combined foaming agents. The foaming agents are mixed with water and air to form foam, which is added to the mixer at step 84. The foam may be continuously added to the calcined gypsum slurry during the manufacturing process.

In particular embodiments, the constituents of foam, such as the foaming agents, water, and air, may be independently introduced into the calcined gypsum slurry. In such embodiments, foam may be formed statically, or without substantial agitation (e.g., without powered electrical independent mixing of foam constituents).

Some of the steps illustrated in FIG. 3 may be combined, modified or deleted where appropriate, and additional steps may also be added to the flowchart. Additionally, steps may be performed in any suitable order without departing from the scope of the invention.

In accordance with a particular embodiment of the present invention, it may be possible to manufacture gypsum board that may be significantly lighter than conventional gypsum board while still capable of meeting or exceeding the ASTM C1396 minimum value for Nail Pull Resistance. It may be possible to manufacture half inch thick gypsum board with excellent “bond” and superior handling properties where the dry board may have a weight of less than 1,500 lbs/MSF. The foamed gypsum slurry may be easier to mix, pour, and form than in conventional gypsum board processing. It may also act in synergy with core additives.

### Laboratory Procedures

As a precursor to board plant trials, laboratory bench experiments were run to determine the most likely foamer blends to select for plant trials. These laboratory experiments utilized the same materials and additives that are used in a gypsum plant, and similar formulations, with minor limitations due to the batch nature of bench experimentation.

With the exception of the gypsum accelerator and the inventive foaming agent blends formed in accordance with particular embodiments of the present invention, all of the materials used in the manufacture of all of the gypsum board core slurry laboratory examples were commercial products, commonly used in the gypsum board industry. The calcined gypsum (stucco) was continuous kettle-calcined commercial gypsum. The gypsum accelerator was made by hand grinding the same gypsum (uncalcined) for a period of one minute immediately prior to core slurry mixing. Water was room temperature distilled water, saturated with the same gypsum used to manufacture the gypsum accelerator.

The starch was LC-211, a dry powder wheat starch product manufactured by ADM/Ogilvie of Montreal, Quebec, Canada. The dispersant was Disal GPS powder, a sodium salt of naphthalene sulfonate polymerized with formaldehyde, manufactured by Handy Chemicals Limited, of Candiac, Quebec, Canada. The boric acid was Boric Acid, Technical Powdered, manufactured by U.S. Borax Inc. of Valencia, Calif., U.S.A.

With the exception of the foaming agents, the same amount by weight of the various core additives were used in the manufacture of all gypsum slurry cubes. That is, 330 grams of calcined gypsum, 2.9 grams of gypsum accelerator, 2.5 grams of starch, 0.5 grams of dispersant, 0.5 grams of boric acid and 205 grams of gauging water. Gauging water is the water used to make up the gypsum slurry mix, not including the water contained in the pre-generated foam.

Each surfactant used was individually prepared by dissolving it at an active concentration of approximately 0.38% in 125 grams of room temperature water in a Hamilton Beach Commercial Drink Mixer Model 936 standard stainless steel cup. In all cases, gypsum board foam was generated by mounting the stainless steel cup containing the dissolved surfactant on a Hamilton Beach Commercial Drink Mixer Model 936 set at the low speed setting, and running the mixer for 10 seconds. Immediately after a foam had been generated, a standard volume of the foam was weighed and immediately added to, and blended with, the main gypsum cube slurry as described below.

Calcined gypsum was weighed into a 2 liter stainless steel beaker (Model 2Y Bain Marie Pot, Polar Ware Company, Sheboygan, Wis., U.S.A.) Using a spatula with a 3/4″ wide by 4″ long stainless steel blade, the starch, dry dispersant, boric acid and gypsum dry powders were manually blended into the calcined gypsum. Gauging water was measured into a mixer pot—another 2.0 liter stainless steel beaker. This mixing pot was placed on the drill press table of a Delta Model 17-965C 16—½ Floor Model Drill Press and a simple stainless steel mixer paddle, with four individual vertical blades ¾″ high by 2¼″ wide, for a total mixer paddle width of 4½″, was inserted into the chuck of the drill press, and centered in the mixing pot, with the bottom of the mixer paddle barely touching the bottom of the mixing pot.

The mixing of the main gypsum board core slurry and the generation of the foam were synchronized, so that a standard volume of the pre-generated foam was added to the mixing pot containing the main gypsum slurry as soon as possible after the main gypsum slurry had been mixed and a standard volume of foam had been simultaneously separately generated and weighed. This was accomplished by first adding the previously blended dry powder materials to the mixing pot containing the gauging water and any liquid additive used, and allowing the dry powders to soak for 60 seconds. At the appropriate time during this 60 seconds soaking period the foam was generated and measured. At the end of the 60 seconds of soaking, the soaked gypsum materials were mixed at 434 RPM for 5 seconds and momentarily stopped, so that the pre-generated, measured foam could be quickly added. Immediately thereafter, the pre-generated foam was mixed into the main gypsum slurry for an additional five seconds at 434 RPM.

At a total elapsed time from the start of powder soaking of 90 seconds, some of the foamed gypsum cube slurry was immediately poured into a polystyrene coffee cup, for thermal set measurement. Most of the rest was quickly poured into three empty, pre-weighed, silicone rubber compressive strength cube molds, 2″×2″×2″ in size, each of which was immediately weighed after filling. The remaining foamed gypsum cube slurry from the mix was poured onto a 5″×5′ clean glass plate to form a “cigar-shaped” patty, so that the slurry “stiffening time” could be measured.

Immediately after the maximum setting temperature of the foamed gypsum slurry had been observed, the three cubes of set foamed gypsum slurry were removed from their molds and dried in a 40 degrees Celsius temperature forced-draft oven until all the cubes had stopped losing weight, after which the compressive strengths of each dried cube was determined.

The compressive strengths of each of the dried set foamed gypsum slurry cubes were determined immediately after removal from the drying oven using a compressive strength testing machine that conformed to ASTM C-472 Standard Test Methods for Physical Testing of Gypsum, Gypsum Plasters and Gypsum Concrete.

The wet and dry densities (lb/ft³) of the foamed gypsum slurry cubes were calculated by separately multiplying the total wet weight (g) and the total dry weight (g) of the three compressive cubes obtained during each experiment by 0.158, respectively. Cube properties and compressive strength data were determined, and significant compressive strength improvements in foamed gypsum slurry cubes formed according to the present invention, compared to foamed gypsum slurry cubes made using conventional mixtures of oligomers of alkyl sulfates and alkyl ether sulfates were observed. Such significant increases in core compressive strength translate into similar increases in the paper/gypsum “bond” strength and in Nail Pull Resistance Test values.

### Plant Manufacturing Trials

High density skim coats were applied to the core bond sides of the face and back papers. Likewise, foam was generated using a positive displacement pump to accurately feed a foaming agent blend formed in accordance with particular embodiments of the present invention to the first of two centrifugal pumps in series, wherein the foam is generated. The foaming agent blend and foam water were fed just prior to the entrance of the first centrifugal pump, followed immediately by the air. After passing through the first of the two centrifugal pumps the blended mixture of foaming agent, air and water was fed to the second pump, but entering the normal exit and exiting the normal inlet to that pump. Line pressure was measured and controlled immediately after both centrifugal pumps. U.S. Pat. No. 5,116,671 illustrates a similar system, which is available commercially from several equipment suppliers.

Significant improvements were found in core compressive strengths, paper/core “bonds” and Nail Pull Resistance Tests of gypsum boards made using the inventive foaming agents, when compared to the values found for the same board physical properties when using conventional foaming agent at the same gypsum board weight, when all the example boards were tested according to ASTM Methods C 473—Test Methods for Physical Testing of Gypsum Panel Products. These advantages allow significant board weight reductions to be achieved by the use of the inventive foaming agents, while still meeting all the requirements of ASTM.

Using a blend of 90/10 Polystep B-25/Cedepal FA-403 as the inventive foaming agent, a gypsum board that exceed the minimum ASTM Nail Pull Resistance value, at a board weight of 1,463 lb/MSF, even without using hard facing technology was manufactured. This compares very favorably with the overall average ASTM Nail Pull Resistance value of 80 lbs-force found for gypsum board manufactured using conventional foaming agents and hard facing technology at an average gypsum board weight of 1,500 lb/MSF.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within a gypsum board manufacturing system, these elements may be combined, rearranged or positioned in order to accommodate particular manufacturing or operational needs. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

What is claimed is:

1. A method for producing a gypsum product, comprising:
providing a calcined gypsum powder; and
combining water, an aqueous foam generated from a foaming agent comprising a first portion of sodium decyl sulfate, and the calcined gypsum powder to generate a foamed calcined gypsum slurry.

2. The method of claim 1, wherein the first portion further comprises sodium dodecyl sulfate.

3. The method of claim 2, wherein the first portion further comprises sodium octyl sulfate.

4. The method of claim 2, wherein the foaming agent further comprises a second portion of ammonium decyl ether sulfate and ammonium octyl ether sulfate.

5. The method of claim 4, wherein the second portion further comprises ammonium decyl sulfate.

6. The method of claim 5, wherein the second portion further comprises ammonium octyl sulfate.

7. The method of claim 2, wherein the first portion comprises a mixture of compounds, conforming to the following formula:
Rₓ(OCH₂CH₂)_{y}OSO₃⁻M⁺; and
where R represents linear or branched chain hydrocarbons, x is equal to 8, 10, and 12 and has an average value of approximately 10.5, y is equal to 0, and M⁺ is a sodium ion.

8. The method of claim 7, wherein the foaming agent further comprises a second portion comprising a mixture of compounds, conforming to the following formula:
Rₓ(OCH₂CH₂)_{y}OSO₃⁻M⁺; and
where R represents linear or branched chain hydrocarbons, x is equal to 8 and 10 and has an average value of approximately 9.5, y is from 0 through 12 with an average value of less than 2.9, and M⁺ is an ammonium ion.

9. The method of claim 5, wherein the water and the foaming agent are combined to generate the aqueous foam, prior to being combined with a calcined gypsum slurry.

10. The method of claim 5, wherein the foamed calcined gypsum slurry comprises the calcined gypsum powder, potassium sulfate, starch, and paper fiber.

11. The method of claim 5, wherein the foaming agent comprises 95 weight percent of the first portion and 5 weight percent of the second portion.

12. The method of claim 5, wherein the foaming agent comprises 90 weight percent of the first portion and 10 weight percent of the second portion.

13. The method of claim 5, wherein the foaming agent comprises 80 weight percent of the first portion and 20 weight percent of the second portion.

14. The method of claim 5, wherein the foaming agent comprises 75 weight percent of the first portion and 25 weight percent of the second portion.

15. The method of claim 5, wherein the foaming agent comprises 70 weight percent of the first portion and 30 weight percent of the second portion.

16. The method of claim 5, wherein the foaming agent comprises from 70 through 95 weight percent of the first portion and from 5 through 30 weight percent of the second portion.

17. The method of claim 9, further comprising continuously mixing the aqueous foam and the calcined gypsum slurry in a pin mixer.

18. The method of claim 5, further comprising depositing the foamed calcined gypsum slurry on a first sheet.

19. The method of claim 18, further comprising:
covering the foamed calcined gypsum slurry with a second sheet to form a gypsum board,
allowing the gypsum board to set, and
heating the gypsum board until the gypsum board is dry.

20. A gypsum composition, comprising:
water;
a calcined gypsum powder; and
an aqueous foam generated from a first foaming agent comprising sodium decyl sulfate.

21. The gypsum composition of claim 20, wherein the first foaming agent further comprises sodium dodecyl sulfate.

22. The gypsum composition of claim 21, wherein the first foaming agent further comprises sodium octyl sulfate.

23. The gypsum composition of claim 21, further comprising a second foaming agent comprising ammonium decyl ether sulfate and ammonium octyl ether sulfate.

24. The gypsum composition of claim 23, wherein the second foaming agent further comprises ammonium decyl sulfate.

25. The gypsum composition of claim 24, wherein the second foaming agent further comprises ammonium octyl sulfate.

26. The gypsum composition of claim 21, wherein the first foaming agent comprises a mixture of compounds, conforming to the following formula:
Rₓ(OCH₂CH₂)_{y}OSO₃⁻-M⁺; and
where R represents linear or branched chain hydrocarbons, x is equal to 8, 10, and 12 and has an average value of approximately 10.5, y is equal to 0, and M⁺ is a sodium ion.

27. The gypsum composition of claim 26, further comprising a second foaming agent comprising a mixture of compounds, conforming to the following formula:
Rₓ(OCH₂CH₂)_{y}OSO₃^{-M}⁺; and
where R represents linear or branched chain hydrocarbons, x is equal to 8 and 10 and has an average value of approximately 9.5, y is from 0 through 12 with an average value of less than 2.9, and M⁺ is an ammonium ion.

28. The gypsum composition of claim 24, wherein the water, the calcined gypsum powder, and the aqueous foam form a calcined gypsum core slurry, and further comprising first and second sheets of paper on opposite sides of the calcined gypsum core slurry forming a gypsum board.

29. The method of claim 1, wherein the foaming agent comprises Polystep B-25.

30. The method of claim 29, wherein the foaming agent further comprises Cedepal FA-403.

31. The gypsum composition of claim 20, wherein the first foaming agent comprises Polystep B-25.

32. The gypsum composition of claim 31, further comprising a second foaming agent comprising Cedepal FA-403.
